(19) United States
(12) Patent Application Publication
(10) Pub. No.: US 2020/0049252 A1
(43) Pub. Date: Feb. 13, 2020

(54) ONE PIECE OIL CONTROL RING FOR INTERNAL COMBUSTION ENGINE

(71) Applicants: Mahle Metal Leve S/A, Jundiai (BR); Mahle International GmbH, Stuttgart (DE)

(72) Inventors: Gisela Ablas Marques, Jundiaí (BR); Paulo Jose Da Rocha Mordente, Jundiai (BR); Paulo Roberto Vieira De Morais, São Bernardo do Campo (BR)

(21) Appl. No.: 16/340,098

(22) PCT Filed: Oct. 5, 2017
(86) PCT No.: PCT/EP2017/075388

§ 371 Date: Apr. 5, 2019

(30) Foreign Application Priority Data
Oct. 7, 2016 (BR) 102016023442 5

(51) Int. Cl. F16J 9/20; F16J 9/26

(52) U.S. Cl. CPC F16J 9/206; F16J 9/26

(57) ABSTRACT

A one piece oil control ring for an internal combustion engine may include a plurality of segments having a metal base and being operatively associated with one another. Each segment of the plurality of segments may define a superior portion and an inferior portion which may both be oriented towards an internal surface of a cylinder liner. The superior portion and the inferior portion may each have a first surface substantially parallel to the internal surface of the cylinder liner wherefrom there may extend a substantially inclined second surface. The metal base may have a tempered martensitic matrix having a hardness of 400 HV to 600 HV. A nitrided layer may be disposed upon all surfaces of each of the plurality of segments.

### CROSS-REFERENCE TO RELATED APPLICATIONS

This application claims priority to International Patent Application No. PCT/EP2017/075388 filed on Oct. 5, 2017, and to Brazilian Patent Application No. BR 10 2016 023442 5 filed on Oct. 7, 2016, the contents of each of which are hereby incorporated by reference in their entirety.

### TECHNICAL FIELD

The present invention relates to an oil control ring for internal combustion engines, particularly a one piece ring applying lower values of tangential force upon a cylinder, including during the running in of the engine, in addition to presenting excellent resistance to wear and durability of the ring.

### BACKGROUND

Internal combustion engines, whether of Diesel cycle, Otto cycle, two or three stroke, comprise at least one piston ring. The piston ring acts in the sealing of the gap between the cylinder liner and the body of the piston, isolating the combustion chamber from the other internal components of the engines. The piston ring is disposed radially upon the base of the body of the piston, preventing the combustion gases from escaping from the combustion chamber in the direction of the sump and precluding the engine oil from penetrating within the combustion chamber.

Normally, the engines are provided with three rings located parallelly in grooves disposed in the base of the piston body, being two compression rings and one oil scraper ring. The compression rings are located more proximately to the head of the piston and seal the clearance existing between piston and liner, rendering it possible that the piston may compress the air-fuel mixture for the combustion and subsequently maintain the hermeticity of the cylinder. On the other hand, the oil scraper rings have the function of scraping the excess lubricant oil thrown under pressure upon the wall of the liners and returning it to the sump, limiting and controlling the thickness of the film of oil and the consumption of oil of the engine. Another important function of the rings is the dissipation of the heat absorbed by the pistons during the combustion, transmitting it to the cooled working faces of the cylinder.

To satisfy these requirements the piston rings require to maintain continuous contact with the cylinder wall along the entire circumference thereof, even should these cylinders present slight deviations in the original shape thereof. By virtue of the high initial forces and the combustion pressure, together with the high loads causing wear, the piston rings require to satisfy the high demands placed upon the materials thereof and also upon the finish of the surface and of the shape.

Oil scraper rings may be divided into three types: one piece, two piece and three piece. The majority of applications utilise oil rings having two or three pieces by virtue of the good overall performance thereof.

The two piece oil ring comprises an annular body provided with two trapezoidal annular projections oriented towards the cylinder liner, the annular body being, usually, of cast iron or of steel and having an internal groove for the housing of an expander element such as, for example, a spring, also annular, this being that responsible for the tangential force from the assembly.

As a general rule, the three piece oil ring comprises a first superior annular segment and a second inferior annular segment, they being associated with an intermediate, expander, element, exerting force in a controlled manner upon the superior and inferior segments to meet the wall of the cylinder. The force exerted by the expanding element, it being nothing more than a resilient element, is calculated such that the film of oil upon the wall of the cylinder presents a predetermined desired thickness.

On the other hand, the application of the one piece oil ring is more restricted by virtue of the fact that presenting a great flexibility, inherent in the design thereof, conferring excellent conformability upon the ring when in operation, moulding easily to the wall of the cylinder, nevertheless the surface finishing thereof is rendered more difficult by virtue of the fact of being segmented, this restricting the finishing methods which might be applied.

Furthermore in the case of the one piece oil ring, as the ring undergoes wear loss of pressure occurs caused by the increase in the area of contact, being very small in this type of ring. In order to solve this problem the ring is designed having a greater initial force, having the disadvantage that this high force may cause greater wear, rendering the solution of the one piece oil ring apparently disadvantageous in relation to the equivalents of two or three pieces.

The document BR102012028094-9 reveals a one piece oil control ring comprising a body defining a superior portion and an inferior portion oriented towards the wall of a cylinder of an internal combustion engine, each portion defining a first surface perpendicular to the body and wherefrom there extends a second inclined surface, the first surface taken together with the second surface defining a first area of contact with the wall of the cylinder such that at least 95% of the first area makes contact with the wall of the cylinder in the initial assembly of the engine, ensuring the correct control of the film of oil, including during running in.

It observed that the state of the art solves in efficacious manner the problem of consumption of fuel of the engine, ensuring a desired and correct thickness for the film of oil. However, the document BR102012028094-9 does not reveal any solution in the sense of reducing the wear experienced by one piece oil rings.

In this respect, until the present time there had not been developed an oil control ring for internal combustion engines, particularly a one piece oil ring, capable of readily conforming to the liner of the cylinder due to the excellent flexibility of the ring, in addition to applying a lower tangential force, including during the running in of the engine and, concomitantly, providing excellent resistance to the wear of the ring, ensuring the correct thickness of the film of oil, reducing the consumption of fuel of the engine with excellent durability of the ring.

### SUMMARY

A first object of the present invention is to provide a one piece oil control ring for internal combustion engines capable of readily conforming to a cylinder liner due to the excellent flexibility of the ring and, concomitantly, applying a lower tangential force, including during the running in of the engine, ensuring the correct thickness of the film of oil and considerably reducing the consumption of fuel of the engine.

And, additionally, an object of the invention is to provide a one piece oil control ring comprising a metal base provided with a substantially soft or ductile core having a contact surface of high hardness.

And, furthermore, an object of the invention is to provide a one piece oil control ring comprising a nitrided layer having high hardness ensuring excellent resistance to wear and, consequently, high durability of the ring.

And, moreover, an object of the invention is to provide a one piece oil control ring comprising a metal base provided with a core of hardness between 400 HV and 600 HV, having a contact surface having a hardness between 800 HV and 1200 HV.

The objects of the present invention are achieved through a one piece oil control ring for internal combustion engines formed by a plurality of operatively associated segments comprising a metal base, each segment defining a superior portion and an inferior portion oriented towards an internal surface of a cylinder liner, each of the superior and inferior portions defining a first surface substantially parallel to the internal surface of the cylinder liner, wherefrom there extends a second substantially inclined surface, each of the segments comprising a metal base having a tempered martensitic matrix of hardness between 400 HV and 600 HV and comprising a nitrided layer provided upon all the surfaces of each of the segments of the ring.

The objects of the present invention are, also, achieved by a ring comprising a nitrided layer provided upon the first and second surfaces of each of the superior and inferior portions of each of the segments of the ring, each of the segments comprising the metal base formed by a steel containing between 5% and 25% by weight of chromium (Cr) and at least 0.45% by weight of carbon (C), the metal base being provided with a core of hardness between 400 HV and 600 HV, each of the segments comprising the metal base being provided with a contact surface having a hardness between 800 HV and 1200 HV, the nitrided layer comprising between 20 micrometres and 120 micrometres in thickness.

The objects of the present invention are, additionally, achieved by a ring comprising each of the segments defining a cross-section profile having a substantially ‘C’ shape, the superior and inferior portions corresponding to the free extremities of the ‘C’, and defining a central portion corresponding to the base of the ‘C’, the nitrided layer comprising a thickness of up to 50% of the cross-section of the central portion of each of the segments, preferentially comprising a thickness between 16% and 24% of the cross-section of the central portion of each of the segments.

### BRIEF DESCRIPTION OF THE DRAWINGS

The present invention shall be described hereinbelow in greater detail, based upon an example of embodiment represented in the drawings. The figures show:

FIG. 1: a representation of the disposition of the oil control ring of the present invention within the interior of a cylinder of an internal combustion engine;

FIG. 2: a perspective view of the oil control ring object of the present invention;

FIG. 3: a representation of a cross-section of a segment of the oil control ring of the present invention, with magnification of the superior portion thereof;

FIG. 4: photographs showing oil control rings of the present invention subsequent to each stage of the execution of the hardening heat treatment and nitriding;

FIG. 5: a comparative graphic of the different values of average hardness obtained in relation to the period of austenitisation and the means of cooling for the oil control ring of the present invention;

FIG. 6: a schematic representation and a photograph of the nitrided layer provided upon the surfaces of the segments forming the oil control ring of the present invention;

FIG. 7: a photograph of the nitrided layer provided upon the surfaces of the segments forming the oil control ring of the present invention; and

FIG. 8: a representation in graph form of the hardness obtained, commencing from the contact surface in the direction of the core of the oil control ring of the present invention.

### DETAILED DESCRIPTION

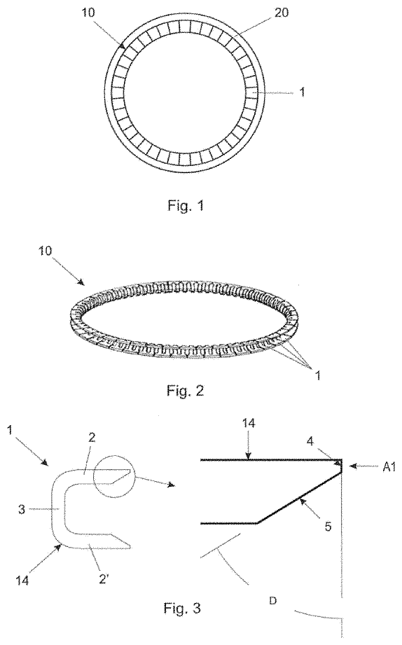

According to a preferential embodiment, and as may be observed in FIGS. 1 and 2, the one piece oil control ring 10 object of the present invention comprises a body formed by a plurality of operatively associated segments 1, each having a degree of freedom of movement in relation to the remainder, conferring upon the ring 10 great flexibility and, consequently, great capacity of adaptation, or moulding, to the format of a cylinder liner 20, ensuring the maintenance of an appropriate film of oil under the most diverse circumstances of operation of the engine.

FIG. 3 illustrates one of the segments 1 forming the body of the ring 10 comprising a cross-section having a substantially ‘C’ shaped format defining a superior portion 2 and an inferior portion 2′ corresponding to the free extremities of the ‘C’, and a central portion 3 corresponding to the base of the ‘C’. The superior and inferior portions 2, 2′ are oriented towards the internal surface of the cylinder liner 20 when the ring 10 is mounted in the groove of a piston. The specific geometry of the ring 10 may vary slightly according to the type of engine for which it has been developed.

Whatever may be the specific geometry of the superior and inferior portions 2, 2′, each thereof defines a first surface 4 substantially parallel to the internal surface of the cylinder liner 20, wherefrom there extends a second substantially inclined surface 5, such that the second surface 5 defines an angle D taken from the prolongation of the first surface 4.

As a result of this geometry of the superior and inferior portions 2, 2′, the first surface 4 defines a first area of contact A1 with the internal surface of the cylinder liner 20, being less than the area defined were the second surface 5 to be at an angle of zero in relation thereto.

The ring 10 of the present invention comprises a structural configuration ensuring that at least 95% of the first area A1 makes contact with the internal surface of the cylinder liner 20 on the initial assembly of the engine. In other words, including in the initial moments of the period of running in of the engine, it is ensured that at least 95% of the first area A1 makes contact with the internal surface of the cylinder liner 20, consequently ensuring the correct control of the film of oil, including during running in.

Consequently, the ring 10 of the present invention does not require to be designed to apply a high tangential force upon the internal surface of the liner 20, by virtue of the fact that is possible to obtain a high percentage of contact between A1 and the internal surface of the liner 20.

Each of the superior and inferior portions 2, 2′ comprises a thickness of up to 0.5 millimetres, such that the first surface 4 comprises a height of up to 0.15 millimetres and the angle D formed by the second surface 5 taken from the prolongation of the first surface 4 comprises an acute angle D equal to or exceeding 30°, preferentially between 45° and 70°.

It must be noted that the body of the ring 10 of the present invention is formed by a plurality of mutually operatively associated segments 1, each segment 1 comprising a cross-section having a substantially ‘C’ shape, wherein two consecutive associated segments 1 define at least one opening for the passage of lubricating oil. The opening for the passage of lubricating oil has at least one corner of straight or rounded format or, furthermore, having any other functional format.

The geometry of the ring 10 of the present invention permits reducing the tangential force exerted by the ring 10 by 50%, ensuring that at least 95% of the first area A1 makes contact with the internal surface of the cylinder liner 20. The lower tangential force applied by the ring 10 results in a reduction in the friction and consequent reduction in the consumption of fuel and emission of CO₂. It is important to observe that, considering solely the mechanical losses, on average 30% of the internal friction of the engine (including exchange of gases and auxiliaries) is generated by the rings and, of this 30%, approximately 50% arises from the oil control ring.

By virtue of its great flexibility, the ring 10 object of the present invention presents a great capacity to adapt/mould/conform to the format of a cylinder liner 20, ensuring the maintenance of an appropriate film of oil under the most diverse circumstances of operation of the engine. It should be noted that the area A1 contacting the internal surface of the liner 20 is very small, comprising up to 0.15 millimetres. In spite of the tangential force applied being lower, the contact pressure of the area A1 with the internal surface of the liner 20 is still very high, considerably accentuating the wear of the ring 10, principally upon the first and second surfaces 4, 5 of the superior and inferior portions 2, 2′.

In this respect, FIG. 6 illustrates the ring 10 of the present invention comprising a nitrided layer 12 provided upon all the surfaces of each of the segments 1 of the ring 10, preferentially provided upon the first and second surfaces 4, 5 of the superior and inferior portions 2, 2′ of each of the segments 1 of the ring 10. The nitrided layer 12 confers high hardness upon the surfaces of the ring 10 and a consequent increase in the resistance to wear thereof.

Each of the segments 1 of the ring 10 is formed by a steel comprising between 5% and 25% by weight of chromium (Cr), preferentially 10% by weight of chromium (Cr), and containing at least 0.45% by weight of carbon (C). The chromium present in the composition of the metal base of the ring 10 permits nitridation of the surfaces thereof in an appropriate manner to increase the resistance to wear, whilst the carbon present permits the realisation of a hardening heat treatment upon the metal base.

The steel utilised as raw material for manufacture of this type of ring must be in the annealed state in order to permit all the stages of mechanical shaping. Following the mechanical shaping, the material must be hardened to permit the subsequent operations of machining, which the steel in the annealed state would not permit.

The heat hardening treatment is realised such as to transform the microstructure of the metal base into martensite, in this manner obtaining a martensitic core having high hardness. Nevertheless, it is noted that the transformation of the metal into martensite may generate superficial microcracks 15 by virtue of the chemical composition having a high chromium content and the small thickness of 0.5 millimetres of the superior and inferior portions 2, 2′. The nitridation may deepen and exacerbate the emergence and propagation of these microcracks 15. All these factors combined may impair the breaking strength of the ring in operation in the engine. Consequently, it is extremely important to control the hardening parameters such as to prevent the occurrence of superficial cracks.

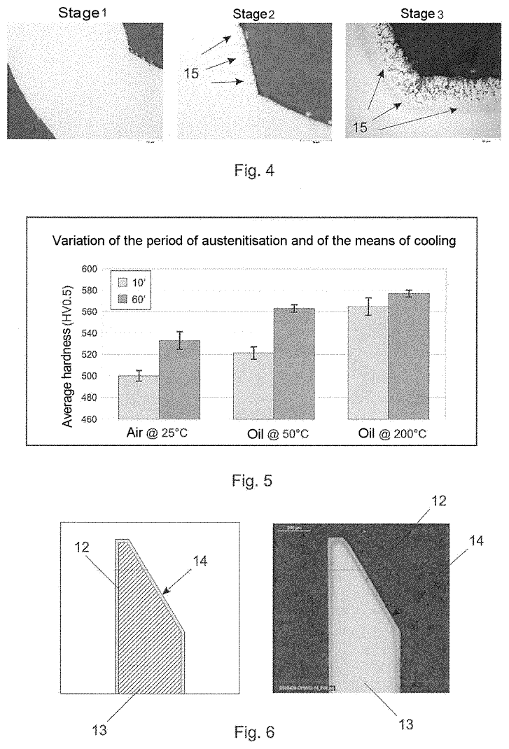

FIG. 4 reveals three photographs showing oil control rings subsequent to the realisation of the hardening heat treatment and nitridation. The objective of the photographs is to illustrate the difficulties encountered and overcome by the oil control ring 10 of the present invention. The photographs reveal:

Stage 1: photograph of a ring subsequent to shaping;

Stage 2: photograph of a ring subsequent to the realisation of a hardening heat treatment. As may be observed, the hardening heat treatment has brought about the emergence of microcracks 15 proximate to the contact surface of the ring;

Stage 3: photograph of a ring subsequent to the realisation of a hardening heat treatment followed by nitridation. It may be observed that the superficial microcracks 15 have considerably increased, proving that the nitridation has deepened and increased the emergence and propagation of microcracks 15 in the metal base of the ring.

Consequently, it is necessary for a careful heat treatment to be realised to render possible the realisation of nitridation upon the surfaces of the ring 10, without aggravating the cracks.

In this respect, each of the segments 1 of the ring 10 of the present invention passes through a tempering heat treatment realised subsequent to the hardening heat treatment. This tempering heat treatment has as objectives alleviation of the stresses generated through the formation of martensite, reduction of the hardness thereof and rendering the core of the ring more ductile, including subsequent to nitridation treatment.

The hardness of the core 13 of the metal base of each of the segments 1 of the ring 10 is operated upon in the hardening and tempering heat treatments, such as to differentiate the period of austenitisation and the means of cooling the material, utilising air, or oil, or oil at 200° C., as principal means of cooling, having the objective of obtaining greater ductility of the core of the material.

The appearance of superficial microcracks 15 is prevented through utilisation of a shorter period of austenitisation, preferentially between 10 and 60 minutes, with temperatures between 850° C. and 1050° C., preferentially between 850° C. and 910° C., followed by a process of cooling which must be realised with a waiting period of between 30 and 120 minutes.

The graph of FIG. 5 presents the average hardnesses obtained for different periods of austenitisation and different means of cooling.

As may be observed in the graph, on realising the austenitisation of the material for a period of 10 minutes it is possible to obtain the following average hardnesses:
Average hardness of approximately 500 HV for cooling in air at ambient temperature (approximately 25° C.);
Average hardness of approximately 520 HV for cooling in oil at a temperature of 50° C.; and
Average hardness of 560 HV for cooling in oil at a temperature of 200° C.

By realising the austenitisation of the material for a period of 60 minutes it is possible to obtain the following average hardnesses:
Average hardness of approximately 530 HV for cooling in air at ambient temperature (approximately 25° C.);
Average hardness of approximately 560 HV for cooling in oil at a temperature of 50° C.; and
Average hardness of 575 HV for cooling in oil at a temperature of 200° C.

Consequently, based upon these periods of austenitisation and means of cooling, it is possible to obtain lower hardness of the core 13 but still with hardened metal. The ring 10 comprises a metal base of tempered martensitic matrix of hardness between 400 HV and 600 HV, preferentially hardness between 450 HV and 580 HV, more preferentially hardness between 500 HV and 550 HV.

Subsequently, the process of nitridation is realised having the objective of obtaining a nitrided layer 12 provided upon all the surfaces 14 of each of the segments 1 of the ring 10, preferentially provided upon the first and second surfaces 4, 5 of the superior and inferior portions 2, 2′ of each of the segments 1 of the ring 10.

The nitrided layer 12 comprises a thickness between 20 and 120 micrometres, preferentially a thickness between 40 and 60 micrometres, more preferentially having a thickness of 60 micrometres.

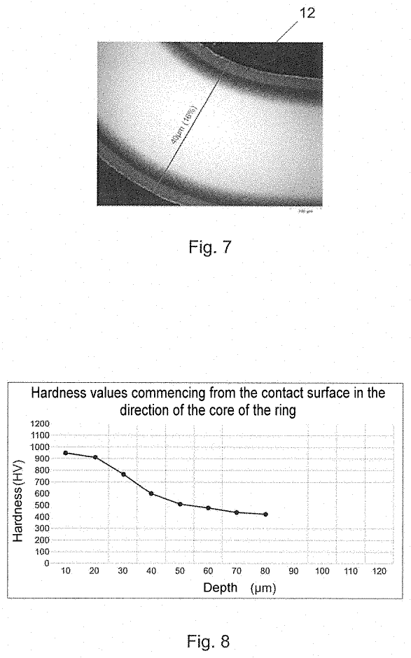

It is important to emphasise that the thickness of the nitrided layer 12 represents a proportion of the cross-section of the ‘C’ shaped profile, particularly taking as reference the central portion 3 of the ‘C’ shaped profile. In this respect, the thickness of the nitrided layer 12 is less than 50% of this cross-section, preferentially between 16% and 24% of the cross-section of the central portion 3 of the segment 1. These values are obtained in the central portion 3 of the segment 1 by virtue of the fact that the breaking of the ring 10 tends to occur precisely in this portion. FIG. 7 illustrates the cross-section of a segment 1 of a ring 10 having a nitrided layer representing 16% of the thickness of this cross-section.

The great novelty of the invention lies in the realisation of the hardening and tempering treatments, permitting obtaining a ring 10 comprising a metal base formed by a more ductile martensitic structure. The core 13 of the material presents a lower hardness, between 400 HV and 600 HV, being substantially soft or ductile, however still obtaining a tempered martensitic matrix for realising nitridation.

The nitrided layer provided upon the surfaces 14 of each of the segments 1 of the ring 10 comprises a hardness between 800 HV and 1200 HV, preferentially a hardness exceeding 1000 HV.

The graph of FIG. 8 presents the variation in hardness of the ring 10, commencing from the contact surface 14 thereof in the direction of the core 13 of the material. It may be observed that for a depth of 10 micrometres (contact surface 14), the ring 10 comprises a hardness between 900 HV and 1000 HV, whilst for a depth of 80 micrometres the hardness of the ring 10 reduces substantially such that the core 13 of the material presents a hardness of the order of 400 HV to 500 HV.

Consequently, the one piece oil control ring 10 of the present invention reveals a ductile core capable of receiving a nitrided layer without the occurrence of the propagation of the superficial microcracks 15 observed in the state of the art (vide FIG. 4).

Furthermore, it may be noted that the metal base of the ring 10 comprises a material wherein are precipitated chromium carbides, including in the core 13 thereof. Consequently, even subsequent to the extinction of the nitrided layer, wear resistant chromium carbides still exist in the core of the material.

In this respect, the ring 10 of the present invention presents an approximately 30% increase in the resistance to wear thereof, significantly increasing the durability of the ring 10, obtaining a nitrided layer at least upon the first and second surfaces 4, 5 of the superior and inferior portions 2, 2′ oriented towards the internal surface of the cylinder liner 20.

In this manner, the ring 10, object of the invention, in addition to applying a lower tangential force, including during the running in of the engine, ensuring correct thickness of the film of oil, reducing the friction and a lower consumption of fuel of the engine, it furthermore comprises an excellent resistance to wear and durability of the ring.

An example of preferred embodiment having been described, it shall be understood that the scope of the present invention comprises other possible variations, being limited solely by the content of the appended claims, the possible equivalents being included therein.

1. A one piece oil control ring for an internal combustion engine, comprising a plurality of segments having a metal base and being operatively associated with one another, each segment of the plurality of segments defining a superior portion and an inferior portion both oriented towards an internal surface of a cylinder liner, the superior portion and the inferior portions each defining a first surface substantially parallel to the internal surface of the cylinder liner wherefrom there extends a substantially inclined second surface, wherein the metal base has a tempered martensitic matrix having a hardness of 400 HV to 600 HV and wherein a nitrided layer is disposed upon all surfaces of each of the plurality of segments.

2. The ring according to claim 1, wherein the nitrided layer is provided upon the first surface and the second surface of each of the superior portion and the inferior portion of each of the plurality of segments.

3. The ring according to claim 1, wherein the metal base is composed of a steel having 5% to 25% by weight of chromium and at least 0.45% by weight of carbon.

4. The ring according to claim 1, wherein the metal base includes a core having a hardness of 400 HV to 600 HV.

5. The ring according to claim 1, wherein the metal with has a contact surface having a hardness of 800 HV to 1200 HV.

6. The ring according to claim 1, wherein the nitrided layer has a thickness of 20 micrometres to 120 micrometres.

7. The ring according to claim 1, wherein each of the plurality of segments defines a cross-sectional profile having a substantially ‘C’ shape, and wherein the superior portion and the inferior portions each define a free extremity of the ‘C’ shape, and a central portion of each of the plurality of segments defines a base of the ‘C’ shape.

8. The ring according to claim 7, wherein the nitrided layer defines a thickness of 50% or less of a cross-section of the central portion.

9. The ring according to claim 7, wherein the nitrided layer defines a thickness of 16% to 24% of a cross-section of the central portion.

10. The ring according to claim 1, wherein the nitrided layer has a thickness of 40 micrometres to 60 micrometres.

11. The ring according to claim 1, wherein the second surface extends relative to the first surface at an angle of 30° or greater.

12. The ring according to claim 1, wherein the second surface extends relative to the first surface at an angle of 45° to 70°.

13. The ring according to claim 1, wherein the superior portion and the inferior portion have a thickness of 0.5 millimetres or less.

14. The ring according to claim 1, wherein the plurality of segments are structured and arranged such that the plurality of segments are movable relative to one another.

15. The ring according to claim 14, wherein the plurality of segments are arranged one after another to define a ring-shape, and wherein at least two consecutively arranged segments of the plurality of segments define at least one opening through which a lubricating oil is flowable.

16. The ring according to claim 4, wherein the core includes precipitated chromium carbides.

17. A one piece oil control ring for an internal combustion engine comprising a plurality of operatively associated segments having a metal base and arranged to define a ring-shape, each of the plurality of segments having a superior portion, an inferior portion, and a central portion, the superior portion and the inferior portion extending radially outward from the central portion relative to an axis of the ring-shape defining a C-shape, the superior portion and the inferior portion each having a first surface facing away from the central portion and a second surface abutting the first surface, the second surface inclined toward an interior of the C-shape, wherein the metal base has a tempered martensitic matrix having a hardness of 400 HV to 600 HV, and wherein a nitrided layer is disposed on all surfaces of each of the plurality of segments.

18. The ring according to claim 17, wherein a core of the metal based has a hardness of 400 HV to 600 HV and a contact surface of the metal base has a hardness of 800 HV to 1200 HV.

19. The ring according to claim 17, wherein the nitrided layer has a thickness of 20 micrometres to 120 micrometres and defines a thickness of 50% or less of a cross-section of the central portion.

20. A one piece oil control ring for an internal combustion engine comprising a plurality of operatively associated segments having a metal base, each of the plurality of segments having a superior portion, an inferior portion, and a central portion extending between the superior portion and the inferior portion defining a cross-sectional profile having a C-shape, the superior portion and the inferior portion each having a first surface lying substantially parallel to the central portion and a second surface abutting the first surface and inclined toward the central portion by an angle of 30° or greater relative to the first surface;
wherein the metal base has a tempered martensitic matrix having a hardness of 400 HV to 600 HV; and
wherein a nitrided layer is disposed on each surface of each of the plurality of segments.
